(19) United States
(12) Patent Application Publication
(10) Pub. No.: US 2024/0335888 A1
(43) Pub. Date: Oct. 10, 2024

(54) ATTACHMENT CONNECTOR MEMBER

(71) Applicant: D'ANDREA SPA, Lainate (IT)

(72) Inventor: Ermanno D'ANDREA, Lainate (IT)

(21) Appl. No.: 18/290,816

(22) PCT Filed: May 31, 2022
(86) PCT No.: PCT/EP2022/064759

§ 371 Date: Jan. 22, 2024

(30) Foreign Application Priority Data
Aug. 5, 2021 (IT) 102021000021272

(51) Int. Cl. B23B 29/04; B23Q 11/10

(52) U.S. Cl. CPC B23B 29/046; B23Q 11/1023; B23B 2231/24

(57) ABSTRACT

Attachment connector member (E), especially for the connection of operating parts (B, M, U) of a machine tool (MO), including a cylindric central body (1), from each other opposite bands in relation to said central body (1), a first portion (3) and a second portion (4) branching there-off; the said second portion (4) including a first surface (6a) exhibiting a trigonal truncated cone configuration (116) and a second end surface (6b) with a cylindric configuration (117).

### DESCRIPTION OF THE INVENTION

The present invention relates to an attachment connector member.

The invention herein is advantageously used in the mechanical manufacturing industry, particularly in the field of the machine tools for the metal parts processing, the following description will explicitly refer thereto without losing generality for this reason.

As it is known, a machine tool operating in the mechanical manufacturing industry for the metal parts processing, is essentially formed by a bearing bed for motorisation members capable of moving in rotation a mechanic mandrel, the selected coupled processing tool is mounted thereon.

To allow for an effective connection being provided with high rigidity and optimal motion transmission between the mentioned mandrel and tool, it is known the use of an attachment connector member capable of being rigidly interposed between the mandrel and the tool body so to mechanically connect them.

The aim of the present invention is to implement an attachment connector member being optimal and with both high rigidity and stability and being capable of allowing the use interchangeability with different types of processing tools.

A further aim of the present invention is to implement an attachment connector member that allows in particular to allow for the execution of effective machining for the chips' removal.

A further aim of the attachment connector member herein is to guarantee the execution of optimal processing even with high force torsion components.

A further aim of the attachment connector member herein is furthermore to allow for a high costs reduction because it needs easy grinding actions for its implementation.

The structural and functional properties of the present invention and its advantages compared to the known prior art will be even more evident from the claims below, and, particularly, from an examination of the following description, done with reference to the attached figures, exhibiting some preferred but not limiting embodiments of the attachment member herein, where:

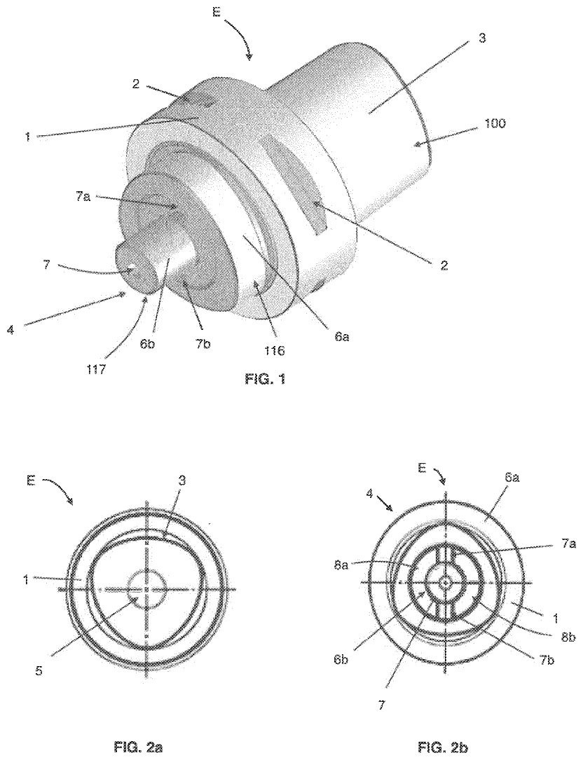

FIG. 1 is a perspective, enlarged scale view of a first preferred embodiment of the attachment connector member herein, in the present invention;

FIG. 2a is a top plan view of the connector member of FIG. 1;

FIG. 2b is a bottom plan view of the connector member of FIG. 1;

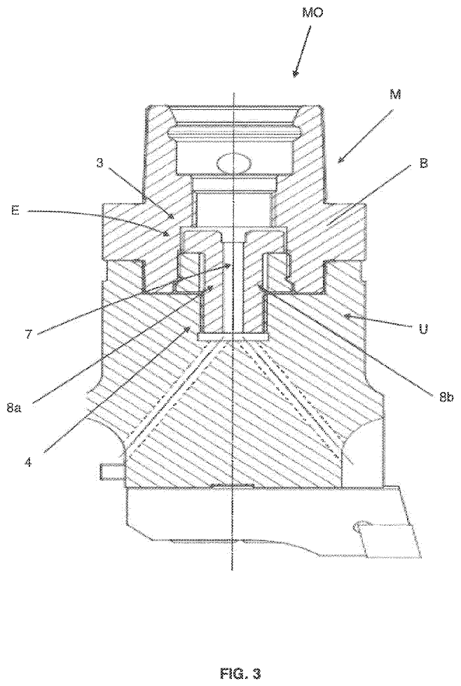

FIG. 3 shows, in a section view, the connector member of FIG. 1 engaged into a mandrel and into a tool of a machine tool for the metal parts processing;

FIG. 4 is a perspective, enlarged scale view of a second preferred embodiment of the attachment connector member herein, in the present invention;

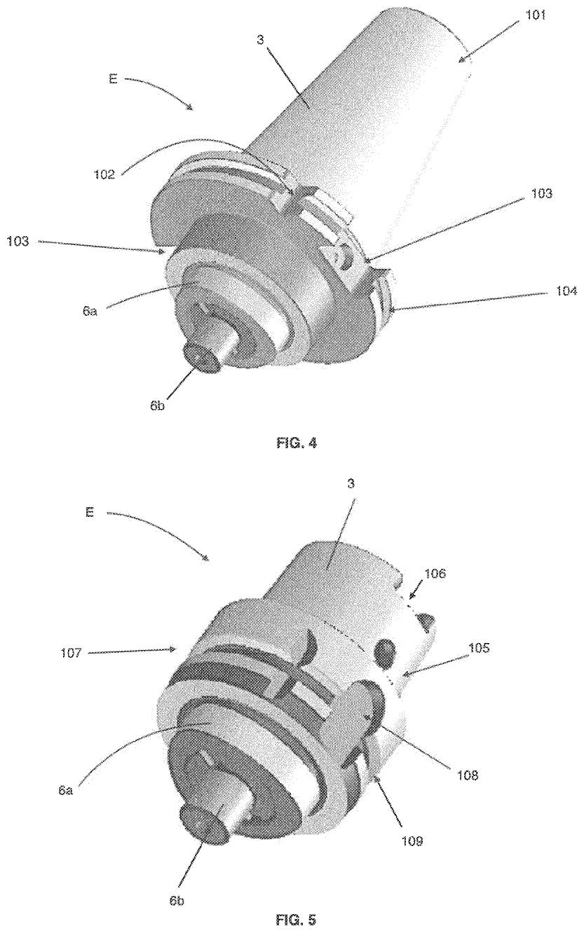

FIG. 5 is a perspective, enlarged scale view of a third preferred embodiment of the attachment connector member herein, in the present invention;

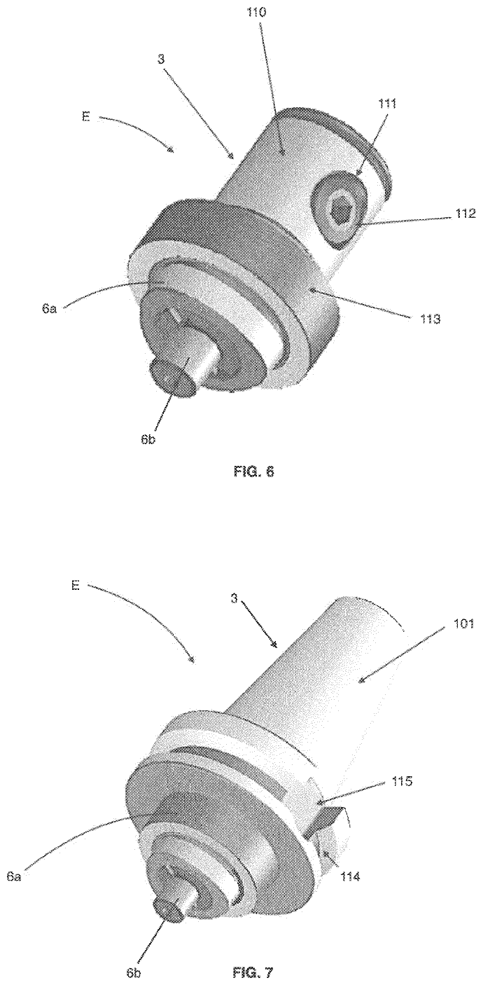

FIG. 6 is a perspective, enlarged scale view of a fourth preferred embodiment of the attachment connector member herein, in the present invention;

FIG. 7 is a perspective, enlarged scale view of a fifth preferred embodiment of the attachment connector member herein, in the present invention. With a specific reference to the attached FIG. 3, with E the attachment connector member is globally referred to, capable, in use, of being engaged, interposed, in a machine tool MO for the metal parts processing, specifically between a base B of a mandrel M of the machine MO and a tool body U.

According to what better illustrated in the FIGS. 1, 2a and 2b, the member E includes a cylindric central body 1, being provided with a series of cross-notches 2, which, from each other opposite bands, in relation to said central body 1, an upper engaging portion 3 (“masculine component”) and a lower engaging portion 4 (“feminine component”) branch there-off.

According to what illustrated in the preferred embodiment of the FIGS. 1, 2a, 2b and 3, the upper engaging portion 3 shows a substantially truncated or truncated cone trigonal configuration 100, and it is capable of being engaged, in use, in the mentioned base B of the mandrel M.

The mentioned upper engaging portion 3 being furthermore provided with a hollow central hole 5.

According to the alternative embodiment illustrated in FIG. 4, the engaging portion 3 shows a substantially truncated cone configuration 101, and furthermore the body 1 being furthermore provided at least with a dihedral notch 102, two recesses 103 with a rectangular section and each other opposing concavities and a cylindric peripheral recess 104.

According to the alternative embodiment illustrated in FIG. 5, the engaging portion 3 shows a substantially cylinder-truncated or truncated cone configuration 105 being provided with an end cut 106, and the body 1 being furthermore provided with at least a notch 107, of a rounded recess 108 and of a cylindric peripheral recess 109.

According to the alternative embodiment illustrated in FIG. 6, the engaged portion 3 shows a substantially cylindric-truncated configuration 110 being provided with a hole 111 for a fastening key nut 112, and the body 1 being furthermore provided with a cylindric peripheral surface 113 without recesses. According to the variant of the alternative embodiment of FIG. 4 and shown in FIG. 7, the body 1 being furthermore provided with a cylindric peripheral surface 114 having a recess 115.

The lower engaging portion 4 includes a first portion 6a exhibiting a truncated or truncated cone trigonal configuration 116, a second portion 6b with a cylindric end configuration 117 branching there-off, being capable, in use, of being engaged in the mentioned tool body U.

The mentioned lower engaging portion 4 being furthermore provided with a hollow centrale hole 7, two cross notches 7a and 7b (FIG. 2b) branching there-off for a fastening key nut of a metal ring 8a capable of closing a threaded tension rod 8b.

The mentioned holes 5 and 7 being communicating, and centrally arranged and axial in relation to member E to allow for the passage and the circulation of a coolant inside the said member E.

In the end it should be noted that the above-mentioned member E being preferably but not limitedly made of steel, or in aluminium alloys, and with various hardness levels, chosen depending on the processing use.

1. The attachment connector member, especially for the connection of operating parts of a machine tool, including a cylindric central body, from each other opposite bands in relation to said central body, a first portion and a second portion branching there-off; characterized in that the said second portion including a first surface exhibiting a trigonal truncated cone configuration and a second end surface with a cylindric configuration.

2. The attachment connector member according to claim 1, characterized in that the said first portion being capable of being engaged in a base of a mandrel being part of the said machine tool; the said second portion being capable of being engaged in a tool body being part of the said machine tool.

3. The attachment connector member according to claim 1, characterized in that the said first portion being further provided with a hollow central hole.

4. The attachment connector member according to claim 1, characterized in that the said second portion being further provided with a hollow central hole, two cross notches branching there-off.

5. The attachment connector member according to claim 1, characterized in that the said first portion exhibiting a substantially trigonal truncated cone configuration.

6. The attachment connector member according to claim 1, characterized in that the said first engaging portion exhibiting a substantially truncated cone configuration; the said body being further provided with at least a dihedral notch, with two recesses with a rectangular section and with opposed concavities, and with a cylindric peripheral recess.

7. The attachment connector member according to claim 1, characterized in that the said first engaging portion exhibiting a substantially truncated cone configuration being provided with an end notch; the said body being further provided with at least a notch, with a rounded recess and with a cylindric peripheral recess.

8. The attachment connector member according to claim 1, characterized in that the first engaging portion exhibiting a substantially truncated cylindric configuration provided with a hole for a fastening key nut; the said body being further provided with a cylindric peripheral surface without cavities.

9. The attachment connector member according to claim 6, characterized in that the said body being further provided with a cylindric peripheral surface provided with a recess.

10. The attachment connector member according to claim 3 characterized in that said hollow central holes being communicating and axially arranged to allow the passage and the circulation of a liquid coolant.

11. Operating machine tool for the machining of metal pieces including at least a mandrel and a tool body, characterized in further comprising an attachment connector member according to claim 1, said connector member being engaged in and between a base of said mandrel and of the said tool body.

12. The attachment connector member according to claim 4, characterized in that said central holes being communicating and axially arranged to allow the passage and the circulation of a liquid coolant.
